(19) United States
(12) Patent Application Publication
(10) Pub. No.: US 2009/0290780 A1
(43) Pub. Date: Nov. 26, 2009

(54) ANALYSIS METHOD FOR CHEMICAL AND/OR BIOLOGICAL SAMPLES

(76) Inventor: Karsten Kottig, Hamburg (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/309,445

(22) PCT Filed: Jul. 17, 2007
(86) PCT No.: PCT/EP2007/057348

§ 371 Date: Jan. 16, 2009

(30) Foreign Application Priority Data
Jul. 17, 2006 (DE) 102006033 294.6

(51) Int. Cl. G06K 9/00

(52) U.S. Cl. 382/133

(57) ABSTRACT

An analysis method for chemical and/or biological samples, particularly chemical and/or biological samples comprising cells, includes the following steps:
taking a sample image (46), said sample image (46) comprising a plurality of pixels,
generating analysis data per pixel,
determining pixels of interest for the analysis, and
evaluating the generated analysis data per pixel of interest, preferably by a fluctuation analysis procedure,
   and is characterized in that said analysis data are generated during said taking of the sample image and comprise pixel information resolved into time series, said pixel information being used for evaluation preferably on the basis of a fluctuation analysis procedure.

### BACKGROUND

1. Field of the Invention

The present disclosure relates to a method for analyzing chemical and/or biological samples.

2. Discussion of the Background Art

Samples of the above type comprise particles, particularly biological cells, which are to be analyzed. The analysis is carried out e.g. by use of screening methods, particularly high-throughput screening methods, which are particularly advantageous when performing research into pharmaceutically active substances. In such methods known in the art, a large number of samples arranged e.g. in the individual wells of a titer plate are examined by use of imaging processes. In doing so, there is generated one sample image per well, particularly by screening. The sample image is taken e.g. by means of a CCD camera or a photodiode, while the sample is subjected to a line-by-line scanning process, for instance. For this purpose, a suitable illumination or excitation beam is generated, e.g. using a laser, and is moved line-by-line within the sample. The radiation emitted by the sample is taken up by a detector device which can comprise a plurality of detectors; these are particularly provided as CCD cameras or photodiodes.

For instance, in a first step, a sample image will be generated in the region of a cell membrane. In the process, the radiation emitted by the sample (e.g. fluorescence emission) is registered, and a corresponding sample image is stored. In a next step, the position of the cell membrane or of another interesting region of the cell is detected, e.g. by application of a threshold method. After detection of an interesting position in the sample image, the corresponding position in the sample will be observed in order to obtain analysis data such as fluctuation data. This is performed by again illuminating or exciting the sample in the region of this position for a longer period of time and measuring the radiation which the sample emits at the interesting position. Then, the thus obtained analysis data are analyzed, e.g. by fluorescence fluctuation analysis. (Wachsmuth, M., Weidemann, T., Muller, G., Hoffmann-Rohrer, U. W., Knoch, T. A., Waldeck, W. & Langowski, J. (2003) “Analyzing intracellular binding and diffusion with continuous fluorescence photobleaching”, Biophys. J. 84, 3353-3363.)

Particularly if high demands are posed to the reading speed, such as e.g. in case of living cells and in the screening of active ingredients, this method suffers the strong drawback that the time period between generating the sample image and determining a position of interest is relatively large so that the cell may already have moved to such an extent that the subsequently captured analysis data are impaired or do not allow for significant conclusions anymore.

Thus, the method known in the art which serves particularly for determining molecular properties in heterogeneous environments such as cellular systems, involves a plurality of successive steps. Particularly, after the image has been taken, an examination of the image is performed to localize areas of interest in the sample. In this process, it often happens that the regions or positions of interest have to be selected manually. Subsequently, there is performed a further take-up of data for the positions of interest, i.e. a renewed take-up of data in the regions of interest. Then, in a further step, the analysis data obtained are analyzed for obtaining molecular information.

It is an object of the disclosure to provide an improved method for analyzing chemical and/or biological samples, particularly chemical and/or biological samples comprising cells, to the effect that the quality of the analysis data is improved.

### SUMMARY

The analysis method for chemical and/or biological samples as proposed by the present disclosure is particularly suited for cellular systems, i.e. samples which include cells. Particularly in cellular systems, local properties of individual regions, e.g. of the cell membrane, the cytoplasma and the nucleus, will yield important information about the overall system. Since the molecular data and attributes of individual regions may be linked to each other, compared to each other and set in relation to each other, cellular processes can be quantitatively described already on the molecular level, and changes can be observed. This will be required particularly when doing research into active substances; in research of this kind, it is important that the analysis data are reliable and are not impaired by artifacts. The analysis method of the disclosure is performed particularly in high-throughput screening wherein a plurality of samples are examined which particularly may be arranged in wells of a titer plate.

In a first step of the analysis method of the disclosure, a sample image is taken. The taking of the sample image is carried out particularly by use of digital imaging techniques. To this end, the sample is preferably scanned in a line-by-line manner. The sample image, which comprises a plurality of individual pixels, is taken preferably by means of CCD cameras, photodiodes or photomultipliers. During the scanning of the sample, the sample is illuminated or excited by radiation in a line-by-line manner. The radiation thus emitted by the sample is detected particularly by pixels. In the process, the region of the sample which corresponds to a pixel is illuminated for a specific period of time, and the radiation emitted by the sample is captured by the corresponding pixel. According to the disclosure, it is already during the acquisition of the image, i.e. while generating the sample image, that analysis data are generated for each individual pixel. Thus, according to the disclosure, the generating of the sample image as well as the generating and respectively storing of the analysis data, are performed at the same time. According to the disclosure, the analysis data comprise pixel information resolved into time series, which information will be later evaluated preferably with the aid of fluctuation analysis methods. The pixel information resolved into time series particularly may comprise information regarding the arrival of photons or the temporal order of photons at a detector. Then, the pixels of interest for the analysis will be determined. This process is carried out by use of known methods, such as e.g. threshold methods, in the sample image. Thereafter, there is performed the evaluation of the pixels of interest for which the analysis data comprising pixel information resolved into time series are already available. Thus, with the aid of the method of the disclosure, the time required for the taking of the data can be considerably reduced. Particularly, this has the advantage that no time interval exists between the generating of the sample image and the detailed observation of individual pixels of interest, like—as described above—it was the case in the state of the art. The risk that, a wrong region is observed due to displacements within the sample occurring in the course of a time difference, will thus be avoided. Also corruption of analysis data caused by other changes over time, as will inevitably occur in living cells, can be prevented. Thereby, the quality of the analysis data can be considerably improved.

Preferably, the time series per pixel is resolved into individual time segments. In the individual time segments, the analysis data are detected. For instance, throughout the time series, a detection is performed of the brightness of the individual sample region, which preferably corresponds to one pixel. At the same time, temporal fluctuation measurements are performed in the individual time segments. The individual analysis data obtained by this analysis will preferably be stored. Particularly for brightness measurement as well as for the determination of fluctuations, the photons impinging onto the pixel are counted within short time segments.

Particularly, the individual data taken for each individual pixel per time segment, such as e.g. the number of photons per time segment, will be stored. For detecting the photons, use is made preferably of a CCD camera or a photodiode, allowing for an extremely fast reading of the measured data per pixel. Suitable detectors in this regard are e.g. the iXON camera manufactured by Andor, or the SPCM photodiodes manufactured by PerkinElmer.

Preferably, the analysis data comprise the individual data, particularly all of the individual data, per pixel. As described above, it is possible, e.g. by counting the photons, to determine the brightness across the whole time series as well as, for fluctuation determination, the number of photons per time segment so that these will then be subjected to a fluctuation analysis.

The time segments per pixel within which the individual analysis data are generated and registered, respectively, are preferably in the range of 100 ns to 10 ms, preferably 1 to 1000 μs, and more preferably in the range of 20 to 200 μs. The overall acquisition time for capturing a time series per pixel is preferably in the range of 0.1 to 100 s. Preferably, the individual time segments for generating analysis data follow each other immediately. If desired, a slight interval may be provided between the time segments. In this interval, the measured data are transferred. According to a further preferred embodiment, the possibility is provided to discard individual time segments and not subject them to further analysis. Such discarded time segments can be time segments in which no photons or merely a very small number of photons arrive at the detector. This preferred embodiment is useful particularly in the framework of the so-called burst integrated lifetime analysis. The embodiment further offers the advantage of allowing a general reduction of data.

According to a particularly preferred embodiment, the determination of the pixels of interest for the analysis is carried out after the acquisition of data. This possibility exists because, according to the disclosure, analysis data are captured during the acquisition of a sample image. Said analysis data already comprise pixel information resolved into time series. Hence, all of the data required for the subsequent determination of the pixels of interest as well as for the subsequent evaluation of data are already available. Thus, advantageously, the determination of the pixels of interest, as well as the evaluation of data, can be decoupled in time from the image acquisition. In this preferred embodiment, ample time will remain for determining the pixels of interest and this determination need not be performed in the shortest possible time for keeping a change of the sample as small as possible. Instead, the pixels of interest, such as e.g. the pixels of the cell membrane, can be selected by use of methods which—although time-consuming—are highly precise. Also the subsequent evaluation of the generated analysis data per pixel of interest can be performed over a longer period of time. For the particularly preferred embodiment of the disclosure, it is thus essential that the determination of the pixels of interest is carried out temporally after the generation of the analysis data.

The pixels of interest can be determined e.g. by a threshold analysis of the sample image. Additionally, use can be made of methods for identification of pixels on the basis of their vicinity, preferably with the aid of convolution methods, model-based algorithms, and neuronal or cluster analysis.

According to a further particularly preferred embodiment of the inventive method, there is carried out a determination of pixel types corresponding e.g. to specific subcellular structures. Such subcellular structures are e.g. the cell membrane, the cytoplasm or the nucleus of a cell. The corresponding pixels in the sample image can be combined into pixel types or pixel groups or be assigned to such types or groups. This has the particular advantage that the analysis data belonging to these pixel types or groups can be evaluated together. For instance, a fluctuation analysis can be performed under inclusion of all analysis data of the cell membrane. This has the effect that the result of the analysis is considerably improved because local variations or measurement inaccuracies will cause merely slight changes of the analysis result.

Particularly, the method of the disclosure offers the advantage that, per measurement point, i.e. per pixel, a high time resolution is made possible so that statistical moments, histograms and/or correlation functions can be generated for each pixel. With the aid of statistic moments, count rates as well as CPP evaluations (CPP=counts per particle) can be implemented. The generation of histograms is possible for further evaluation by means of the analysis methods FIDA and FIDA 2D. Correlation data are needed e.g. for FCS evaluations and FCCS evaluations. It is of particular advantage if the information obtained by analysis of individual time series with the aid of a molecular interpretation can be defined directly in the form of image attributes (local concentration, molecular brightness, diffusion time, number of particles etc.), To this end, according to this method, the temporally resolved pixel information will either be converted to a pixel brightness and/or color value directly via a mathematical function or, by means of optimization methods, parameters will be iteratively adapted corresponding to a molecular model so that, for instance, the average dwelling time of a particle within the pixel under observation can be converted into a diffusion time. These pixel-dependent parameters can then again be converted to image information such as brightness or color values. For instance, instead of the commonly used integrated brightness information per pixel, the pixel brightness value can now represent the particle diffusion time per pixel.

A further advantage of the method of the disclosure is that, due to the pixel-wise interpretation of fluctuation information, more information is obtained per pixel, allowing e.g. for a sharper separation between individual regions of the sample. For instance, an image with homogeneous intensity (countrate per pixel) may indeed vary in its molecular brightness (countrate per molecule).

Particularly, using the analysis method of the disclosure, the following analyses can be performed:

Mask combined traces (additive 2D histograms): In this case, the time-resolved pixel information (2-channel countrate with a time resolution of e.g. 2 μs) is first combined on a new time basis (typically 40 μs) by summation over time segments. Further, these pixel-wise fluctuation traces are combined into a 2D-histogram per pixel corresponding to the FIDA2D data processing. Using a mask (e.g. cytoplasma region of a cell), these histograms are combined and fitted with the aid of the corresponding theory (e.g. FIDA2D).

Mask combined traces (single-trace FCS fitting): In this case, the time-resolved pixel information (channel-dependent count rate with a time resolution of e.g. 1 μs) is selected using a mask (e.g. the mask of all cell nucleus pixels), is combined as a total trace and will then be mathematically processed, usually autocorrelated, and fitted.

Mask combined traces (multi-trace fitting): In this case, the time-resolved pixel information (channel-dependent countrate with a time resolution of e.g. 1 μs) is autocorrelated. Due to the short measuring time per pixel (typically 1-100 ms), the correlation function can be fitted only in a restricted manner; thus, in a combined-fitting approach, various pixel traces are observed together. These pixel traces have been generated beforehand by mask generation with the aid of cell recognition routines. This means that a membrane recognition routine will generate an individual mask for each cell (e.g. using the “objects stencil” library function provided in the “Acapella” image analysis software by Evotec Technologies GmbH, Hamburg, Germany), and this mask will serve as a selection aid for the pixel traces.

### BRIEF DESCRIPTION OF THE DRAWINGS

A preferred embodiment of the disclosure will be explained in greater detail hereunder with reference to the accompanying drawings.

FIG. 1 shows a schematic representation of a device suited for practicing the method;

FIG. 2 shows an example of a sample image and of the analysis data obtained at individual pixels; and

FIG. 3 is a flowchart of a preferred variant of the method of the disclosure.

### DETAILED DESCRIPTION OF THE PREFERRED EMBODIMENT

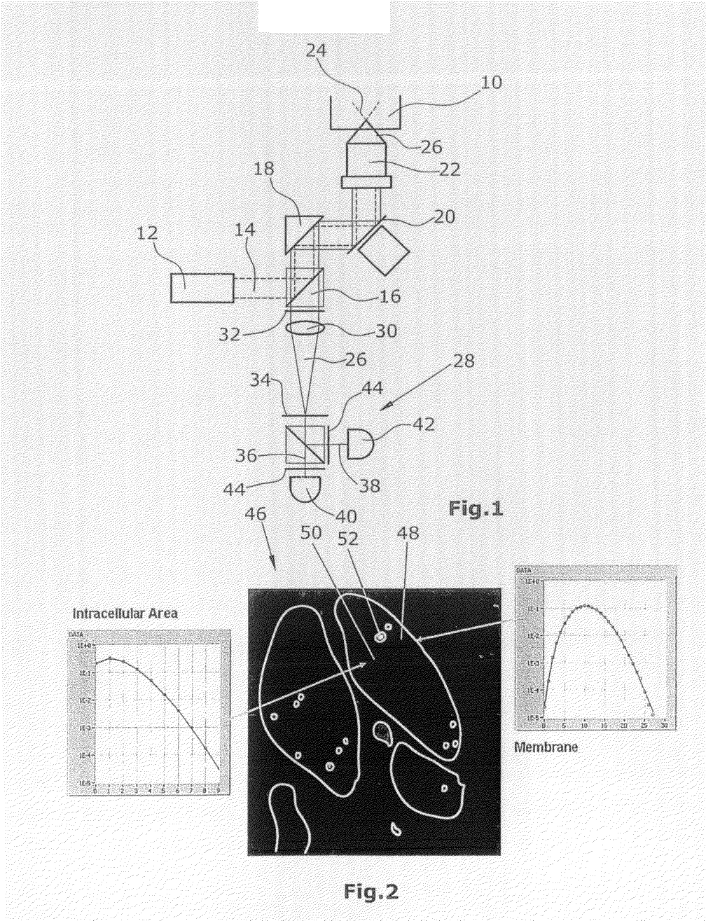

For practicing the method of the disclosure, e.g. a device as schematically shown in FIG. 1 is suited. In the process, a sample 10 is illuminated and excited, respectively, by means of an excitation device, e.g. a laser device. The excitation beam 14 is guided via a dichroic mirror 16, a prism 18 and a moveable mirror 20 towards an objective 22 and, from the latter, into the sample 10 and is focused therein. The focusing point 24 is moved within the sample by moving the mirror 20 so that the sample 10 is scanned for generating a sample image. The radiation 26 emitted by the sample is received by the objective and is guided, via the mirror 20 and the prism 18 and through the dichroic mirror 16 towards a detection device 28. In the process, the beam is bundled by a tube lens 30, which—if required—has an optical filter 32 arranged upstream thereof, and is guided through a pinhole diaphragm 34, if required. Using a beam splitter arranged behind the pinhole diaphragm, or a polarization device, the beam 26 is split into two parts 36,38. Each of these partial beams 36,38 is detected in a pixel-wise manner by a detector 40 and 42, respectively, which is provided particularly as a photodetector. If required, a color filter 44 is arranged upstream of the detector. According to an alternative embodiment (not illustrated in FIG. 1), it is preferred to arrange a CCD camera at the position of the pinhole diaphragm and instead of the latter.

To allow for a fast reading of the individual pixels, the detectors 40,42 are connected to a control device (not illustrated). Particularly, the control device comprises a processor for analyzing the data, as well as a bulk memory.

An example of a sample image 46 of a cellular sample is illustrated in FIG. 2. Within the image of the sample shown in FIG. 2 the cell membranes and the nuclei were highlighted by a white line. The image shown is a brightness image of a sample wherein the brightness has been detected for each individual pixel in a line-by-line manner. Clearly visible in FIG. 2 are a cell membrane 48, the cytoplasm 50 and also the cell nucleus 52.

As described above, according to the disclosure, analysis data have been generated and stored for each pixel simultaneously with the data acquisition for generating the sample image 46. There have been stored, for instance, the analysis data of a pixel of the cell membrane 48. The individual analysis data can be gathered from the histogram on the right-hand side of FIG. 2.

The analysis data of an intracellular pixel, which have also been recorded during the acquisition of the sample image, can be gathered from the histogram on the left-hand side of FIG. 2.

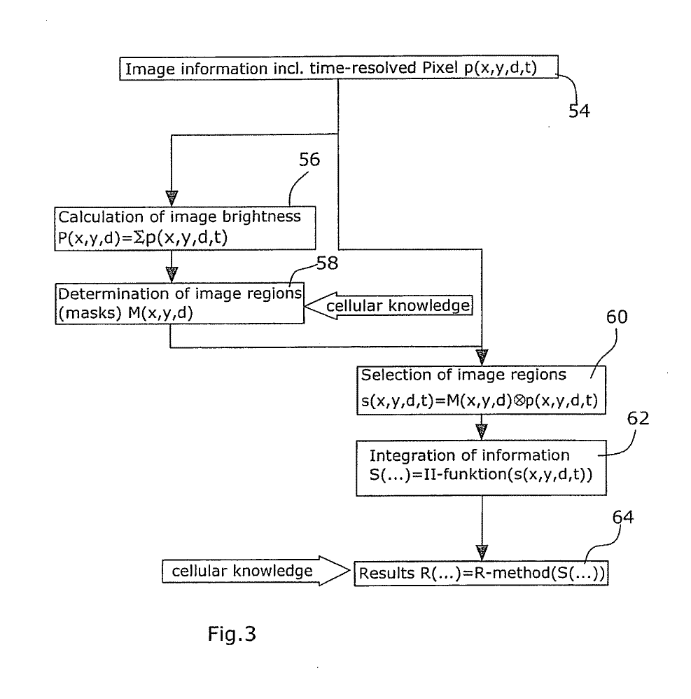

According to the preferred variant of the method of the disclosure illustrated in FIG. 3, a determination is performed particularly of pixel types assigned e.g. to the cell membrane, the cytoplasm or the nucleus. In a first step 54, the image information inclusive of the time-resolved pixel information is stored. In step 56, the image brightness is calculated, i.e. the intensity of the individual pixels of the image taken. Then, in step 58, specific image regions are determined, particularly with the aid of masks. These image regions can be e.g. the cell membrane, the cytoplasm, the cell nucleus or the background. The image regions correspond to pixel types. In step 60, by linking the image information from step 54 to the image regions from step 58, image regions are selected and combined into a group. The information of the individual pixels of these groups, i.e. the group analysis data, will be derived in the subsequent step 62, e.g. by integration. The subsequent analysis is effected e.g. by correlating of the selected group analysis data. The result obtained from this process will lead—via a further evaluation step such as e.g. the fitting according to a further FCS model—to molecular results (step 64).

In the equation shown in FIG. 3, the parameters x and y represent the image pixel positions, d represents an additional dimension such as e.g. the z-coordinate of the pixels, and t represents the fluctuation time.

1. An analysis method for chemical and/or biological samples, particularly chemical and/or biological samples comprising cells, said method including the following steps:
taking a sample image, said sample image comprising a plurality of pixels,
generating analysis data per pixel,
determining pixels of interest for the analysis, and
evaluating the generated analysis data per pixel of interest, preferably by fluctuation analysis procedures,
whereby said analysis data are generated during said taking of the sample image and comprise pixel information resolved into time series, said pixel information being used for evaluation preferably on the basis of a fluctuation analysis procedure and whereby the analysis data of a plurality of pixels of interest are combined into group analysis data to be evaluated together.

2. The analysis method according to claim 1, wherein, in a sample comprising at least one, preferably a multitude of cells, pixel types are determined in dependence on subcellular structures.

3. The analysis method according to claim 2, wherein the analysis data of pixel types are combined into group analysis data to be evaluated together.

4. The analysis method according to claim 1, wherein the pixels of interest are determined with the aid of a threshold analysis.

5. The analysis method according to claim 1, wherein the fluctuation analysis procedure comprises fluorescence correlation spectroscopy, one- or multi-dimensional fluorescence intensity distribution analysis, fluorescence intensity multiple distribution analysis, fluorescence intensity lifetime distribution analysis, one- or multi-dimensional photon counting histogram analysis, photon arrival-time interval distribution analysis, and/or burst-integrated fluorescence lifetime analysis.

6. The analysis method according to claim 1, wherein the analysis data of a plurality of pixels of interest are combined into group analysis data by adding the time series acquired for multiple pixels.

7. The analysis method according to claim 1, wherein the analysis data of a plurality of pixels of interest are combined into group analysis data by:
for each pixel, combining the time series into a histogram per pixel, and
combining said histograms into a group histogram.

8. The analysis method according to claim 1, wherein the analysis data of a plurality of pixels of interest are combined into group analysis data by:
for each pixel, combining the time series into an autocorrelation function per pixel, and
evaluating said autocorrelation functions together, preferably by combined fitting of said autocorrelation functions.

9. The analysis method according to claim 8, wherein the pixel traces have been generated beforehand by mask generation, particularly with the aid of cell recognition routines.

10. The analysis method according to claim 1, wherein said time series is resolved into individual time segments and wherein, in said time segments, preferably the arrival of photons is observed.

11. The analysis method according to claim 1, wherein the analysis data of a pixel comprise individual data which are taken per time segment and particularly are stored per time segment.

12. The analysis method according to claim 11, wherein the numbers of arrived photons per time segment are detected as said individual data.

13. The analysis method according to claim 11, wherein the temporal intervals between arrived photons are detected as said individual data, the detection being preferably performed within time segments.

14. The analysis method according to claim 11, wherein said time segments have a length of 100 ns to 10 ms.

15. The analysis method according to claim 1, wherein the time for taking a sample image is 0.1 to 100 s.

16. The analysis method according to claim 1, wherein the determining of the pixels of interest is performed temporally after the generating of the analysis data.
